(19) United States
(12) Patent Application Publication
(10) Pub. No.: US 2025/0000303 A1
(43) Pub. Date: Jan. 2, 2025

(54) AUTOMATIC FOOD ITEM FEEDER AND PROCESSOR SYSTEM

(71) Applicants: Vasanth Chaganti, Cary, NC (US); Suparna Chaganti, Cary, NC (US)

(72) Inventors: Avula Sampath Pavan Kumar, Bangalore (IN); Vasanth Chaganti, Cary, NC (US); Suparna Chaganti, Cary, NC (US)

(21) Appl. No.: 18/217,563

(22) Filed: Jul. 1, 2023

(51) Int. Cl. A47J 43/07; A47J 43/046

(52) U.S. Cl. CPC A47J 43/0772; A47J 43/046; A47J 43/0716; A47J 43/0794

(57) ABSTRACT

Embodiments herein provide an automatic food item feeder and processor system including a feeder, a pusher, and a cutting portion. The feeder receives at least one food item. The pusher pushes the at least one food item inside the automatic food item feeder and processor system. The cutting portion processes the at least one food item. The automatic food item feeder and processor system include helical conical roller shafts that feeds the at least one food item from the feeder to the cutting portion in a rotary motion. When in operation, the helical conical roller shafts are configured to create a feed motion by gripping and pushing the at least one food item to the cutting portion to cut the at least one food item in a pre-determined requirement with a rotary and push force.

### BACKGROUND

### Technical Field

Embodiments of this disclosure generally relate to food item processing systems, and more particularly, to an automatic food item feeder and processor system to cut at least one food item with less manual efforts and processing time.

### Description of the Related Art

Food chopper is a kitchen tool that has been used for many years to help people chop, dice, and mince food items quickly and efficiently. The food chopper includes a bowl with a hand-cranked blade which is used to chop vegetables, fruits, and meats. Over time, the design of food choppers has evolved, with new features and materials being introduced to improve their performance and durability. While those food choppers provide some benefits, the food choppers include limited functionality, which may not be suitable for processing certain types of food items, such as hard vegetables, meats with bones, or large quantities of food, and provide inconsistent results, as the food items may be over-chopped or under-chopped depending on the type of food, and size of the blades.

The food choppers chopping the vegetables can be a time-consuming task which requires significant effort to hold, grip, and press the vegetables into the food chopper, where the existing food chopper may not provide enough support or grip for the vegetables, making it difficult for users to chop the vegetables effectively. And, the existing food chopper may not be versatile enough to handle different types of vegetables and their varying textures, resulting in use of different products to process different vegetables for various purposes, which is a time-consuming process and also lead to additional costs associated with purchasing multiple products.

The existing food chopper may not include safety features to prevent motor from starting if jars are not placed in a correct position, which may enable users to accidentally come into contact with blades if the jars are not secured properly. And also, the motor starting without the jars placed in the correct position can lead to potential wastage of electricity and cause damage to the chopper over time.

Accordingly, there remains a need to address aforementioned technical draw backs in existing known technologies in the food choppers with auto feeder and multi process of variety of food items in less manual efforts and processing time.

### SUMMARY

In view of foregoing, an embodiment herein provides an automatic food item feeder and processor system including a feeder, a pusher, and a cutting portion. The feeder receives at least one food item. The pusher pushes the at least one food item inside the automatic food item feeder and processor system. The cutting portion processes the at least one food item. The automatic food item feeder and processor system include helical conical roller shafts that feeds the at least one food item from the feeder to the cutting portion in a rotary motion. When in operation, the helical conical roller shafts are configured to create a feed motion by gripping and pushing the at least one food item to the cutting portion to cut the at least one food item in a pre-determined requirement with a rotary and push force.

In some embodiments, the helical conical roller shafts further include one or more drive roller shafts and one or more driven roller shafts. The one or more drive roller shafts are configured to initiate the rotary motion and the one or more driven roller shafts are configured to drive by the one or more drive roller shafts, that creates the feed motion for the at least one food item.

In some embodiments, the one or more drive roller shafts and the one or more driven roller shafts are in any of a vertical position, a vertical slanting position, a horizontal position, or a horizontal slanting position, to create the feed motion in the automatic food item feeder and processor system.

In some embodiments, the one or more drive roller shafts and the one or more driven roller shafts automates a feeding operation of the at least one food item by gripping and pushing the at least one food item to the cutting portion.

In some embodiments, the helical conical roller shafts further include a spring mechanism that enables at least one of a contraction motion or an expansion motion of the one or more drive roller shafts and the one or more driven roller shafts.

In some embodiments, the automatic food item feeder and processor system further includes a guideway that is configured to confine a size of the at least one food item to enter on the feeder.

In some embodiments, the automatic food item feeder and processor system further includes a collector that receives the cut food items.

In some embodiments, the automatic food item feeder and processor system includes a control unit and a motor that are configured to perform the feeding operation of the at least one food item to the cutting portion.

In some embodiments, the cutting portion includes at least one of dicer blades, choppers, or rotary blades to cut the at least one food item. The automatic food item feeder and processor system enables the cutting portion to any of chop, slice, mince, or grate the at least one food item.

In an aspect, an embodiment herein provides a method for cutting at least one food item in an automatic food item feeder and processor system. The method includes receiving the at least one food item using a feeder. The method includes pushing the at least one food item inside the automatic food item feeder and processor system using a pusher. The method includes feeding the at least one food item from the feeder to a cutting portion in a rotary motion using helical conical roller shafts. The helical conical roller shafts creates a feed motion by gripping and pushing the at least one food item to the cutting portion to cut the at least one food item in a pre-determined requirement with a rotary and push force.

In some embodiments, the method includes creating the feed motion for the at least one food item using one or more drive roller shafts and one or more driven roller shafts. The one or more drive roller shafts are configured to initiate the rotary motion and the one or more driven roller shafts are configured to drive by the one or more drive roller shafts.

In some embodiments, the method includes automating a feeding operation of the at least one food item by gripping and pushing the at least one food item to the cutting portion using the one or more drive roller shafts and the one or more driven roller shafts.

In some embodiments, the method includes enabling at least one of a contraction motion or an expansion motion of the one or more drive roller shafts and the one or more driven roller shafts using the helical conical roller shafts including a spring mechanism.

In some embodiments, the method includes confining a size of the at least one food item to enter into the feeder using a guideway.

In some embodiments, the method includes receiving the cut food items using a collector.

In some embodiments, the method includes performing the feeding operation of the at least one food item to the cutting portion using a control unit.

The automatic food item feeder and processor system is highly flexible and adaptable, capable of handling different food items and cutting styles, resulting in achieving precise and desired outputs. The automatic food item feeder and processor system provides a versatile, effective, and easy way to use, providing a quick and accurate way to process the at least one food item with its flexible cutting options and user-friendly design. The automatic food item feeder and processor system is compatible with a wide range of all the food items, and can effortlessly cut the food items into the pre-determined requirements based on a selected processing method. The automatic food item feeder and processor system ensures safe and efficient collection of the at least one food item with the first sensor and the second sensor. The automatic food item feeder and processor system enables the food processing process only when components of the automatic food item feeder and processor system are correctly positioned, thereby minimizing risk of accidents or malfunctions when the components are not correctly positioned.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a block diagram of an automatic food item feeder and processor system for according to some embodiments herein;

FIG. 2 illustrates an exemplary isometric view of the automatic food item feeder and processor system of FIG. 1 according to some embodiments herein;

FIGS. 3A-3W illustrate exemplary views of the automatic food item feeder and processor system of FIG. 2 according to some embodiments herein;

FIGS. 4A and 4B illustrate exemplary views of the automatic food item feeder and processor system according to some embodiments herein; and

FIG. 5 illustrates a flow diagram of a method for cutting the at least one food item in the automatic food item feeder and processor system according to some embodiments herein;

### DETAILED DESCRIPTION OF PREFERRED EMBODIMENTS

The embodiments herein and the various features and advantageous details thereof are explained fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

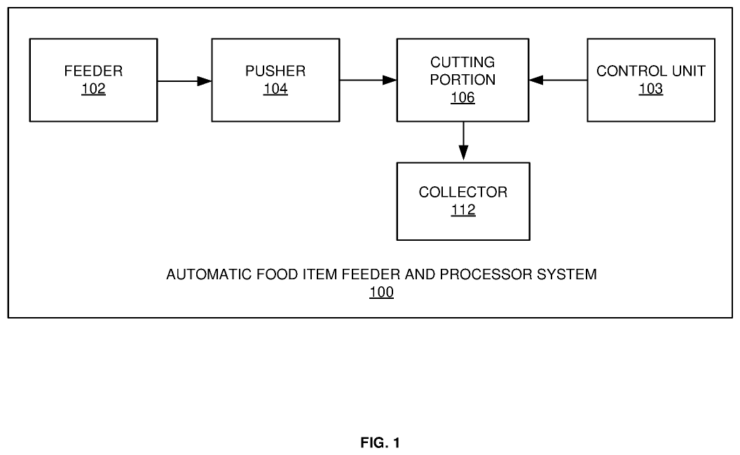

As mentioned, there remains a need for an automatic food item feeder and processor system with auto feeder and multi process of variety of food items in less manual efforts and processing time. Referring now to the drawings, and particularly to FIGS. 1 through 5, where similar reference characters denote corresponding features consistently throughout the figures, there are shown preferred embodiments.

FIG. 1 illustrates a block diagram of an automatic food item feeder and processor system 100 for according to some embodiments herein. The automatic food item feeder and processor system 100 includes a feeder 102, a pusher 104, a cutting portion 106, a control unit 110 and a collector 112. The feeder 102 is configured to receive the at least one food item. The at least one food item may be, but not limited to, fruits, vegetables, cheese, meat, nuts, coffee, beans and baked products. In some embodiments, the feeder 102 can be circular or rectangular in shape to accommodate one or more varieties of the at least one food item. For example, the feeder 102 may be in the circular or rectangular in shape allowing the automatic food item feeder and processor system 100 to handle small fruits and vegetables, and large fruits and vegetables. The pusher 104 is configured to push the at least one food item inside the automatic food item feeder and processor system 100. In some embodiments, the pusher 104 includes a spring-loaded mechanism that advances the at least one food item for the steady flow of the at least one food item into the automatic food item feeder and processor system 100 without any jams or blockages.

The cutting portion 106 is configured to process the at least one food item. In some embodiments, the pusher 104 pushes the at least one food item to the cutting portion 106. The automatic food item feeder and processor system 100 include a feeder mechanism including roller shafts that feeds the at least one food item from the feeder 102 to the cutting portion 106 in a rotary motion. In some embodiments, the roller shafts can be a helical conical roller shafts 108. The pusher 104 may provide a spring-loaded force that pushes and feeds the at least one food item onto the helical conical roller shafts 108. The helical conical roller shafts 108 are configured to create a feed motion by gripping and pushing the at least one food item to the cutting portion to cut the at least one food item in a pre-determined requirement with a rotary and push force. The feed motion may be created with a combination of the rotary force and the push force created by the pusher 104 and the helical conical roller shafts 108. In some embodiments, the pre-determined requirement can be determined based on the required process of the at least one food item. In some embodiments, the pre-determined requirement can be modified based on the at least one food item. For example, softer food items may require less force than harder food items, where the required process can be selected in the automatic food item feeder and processor system 100 before feeding the at least one food item.

The cutting portion 106 that receives the at least one food item from the helical conical roller shafts 108 may perform one or more processes on the at least one food item including any of cutting, chopping, slicing, mincing, dicing, grating, julienne cutting, shredding, cubing, brunoise-cutting, and the like. The cutting portion 106 includes at least one of dicer blades, choppers, or rotary blades to cut the at least one food item in the one or more processes on the at least one food item. The cutting portion 106 may include a multi-stage blade system to cut the at least one food item. In some embodiments, a user can select the required process for the at least one food item before feeding the at least one food item into the automatic food item feeder and processor system 100. The automatic food item feeder and processor system 100 may include any of a control panel, an user interface, or one or more push buttons, enabling the users to choose the required process for the at least one food item. For example, if the user needs to prepare a fresh salad with cucumbers, apples, and carrots, the user can provide the required settings in the automatic food item feeder and processor system 100 with the control panel or the user interface. In some embodiments, the cucumbers can be provided with a dicing process, the apples can be provided with a cutting process, and the carrots can be provided with a shredding process, which enables the automatic food item feeder and processor system 100 to prepare the fresh salad within a short time by automating time-consuming and manual power processes.

The control unit 110 is configured to perform the feeding operation of the at least one food item to the cutting portion 106 from the feeder 102, and the required process on the automatic food item feeder and processor system 100 to obtain cut food items. In some embodiments, the control unit 110 includes a motor that is configured to provide the rotary motion on the helical conical roller shafts 108. The collector 112 is configured to receive and collect the cut food items which can be used for cooking.

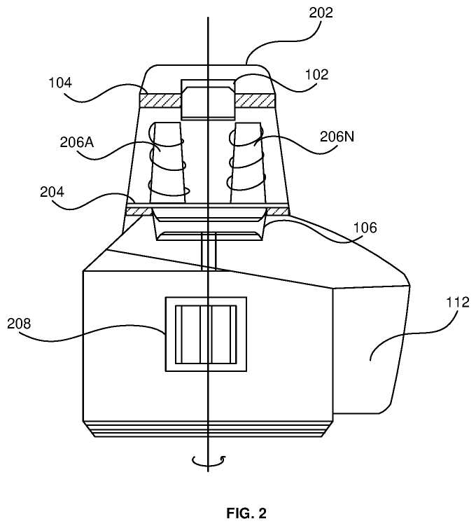

FIG. 2 illustrates an exemplary isometric view of the automatic food item feeder and processor system 100 of FIG. 1 according to some embodiments herein. The automatic food item feeder and processor system 100 includes the feeder 102, pusher 104, the cutting portion 106, the collector 112, a top cap 202, a live rotor 204, one or more idol rotors 206A-N, and a motor 208. The top cap 202 is located at an uppermost part of the automatic food item feeder and processor system 100. The feeder 102 is in the top portion of the top cap 202 with a provision that enables entry of the at least one food item inside the automatic food item feeder and processor system 100. In some embodiments, the provision enables receiving one or more varieties of the at least food item in different shapes and sizes. The pusher 104 pushes the at least one food item from the feeder 102 towards the cutting portion 106, where the at least food item moves to the one or more idol rotors 206A-N. In some embodiments, the automatic food item feeder and processor system 100 includes a guideway that is configured to confine and restrict a size of the at least one food item to enter into the portion of the one or more idol rotors 206A-N.

The one or more idol rotors 206A-N are connected with the live rotor 204, and the live rotor 204 is electrically connected with the motor 208. In some embodiments, the one or more idol rotors 206A-N can be the helical conical roller shafts 108 which is made of any of nylon or food grade rubber. In some embodiments, the live rotor 204 is a rotating plate where the one or more idol rotors 206A-N are placed above the rotating plate. The motor 208 generates and provides the rotary motion to the live rotor 204, which in turn rotates the rotating plate with the rotary force, and the one or more idol rotors 206A-N on rotation, creates the feed motion by gripping and pushing the at least one food item to the cutting portion 106 with the push force. The cutting portion includes a dicer blade 210, and a chopper 212, that is configured to process the at least one food item. The collector 112 receives and stores the cut food items.

For example, the automatic food item feeder and processor system 100 handles a wide variety of vegetables with utmost precision. The feeder 102 effectively receives and positions vegetables of different sizes and shapes for processing. The pusher 104 pushes the vegetables inside the automatic food item feeder and processor system 100, ensuring a smooth and continuous feeding process. The cutting portion 106 with specialized blades and cutting mechanisms, processes the vegetables according to the pre-determined requirements including any of julienne, slices, or cubes with consistent and accurate cuts. The helical conical roller shafts 108 smoothly transport the vegetables from the feeder 102 to the cutting portion 106, enabling the feed motion that ensures optimal cutting results for each vegetable type.

In another example, the automatic food item feeder and processor system 100 provides exceptional performance and versatility for a wide variety of fruits. The feeder 102 receives and accommodates a diverse range of fruits, including any of a soft fruit variety or a hard fruit variety. The pusher 104 guides the fruits into the automatic food item feeder and processor system 100. The cutting portion 106 with the specialized blades and cutting mechanisms, processes the fruits according to the pre-determined requirements including any of slicing, wedges, or intricate decorative cuts with consistent and precise cuts. The helical conical roller shafts 108 facilitate a seamless transfer of fruits from the feeder 102 to the cutting portion 106 with the feed motion that enables accurate and efficient cutting of different fruit types.

In yet another example, the automatic food item feeder and processor system 100 provides a versatile performance for processing other food items including meats, cheeses, bread, and the like. The pusher 104 guides the other food items into the automatic food item feeder and processor system 100. The cutting portion 106 with the specialized blades and cutting mechanisms, processes the other food items according to the pre-determined requirements including any of precise cuts with thin slices, cubes or specific shapes. The helical conical roller shafts 108 provides the feed motion ensuring optimal cutting of other food items.

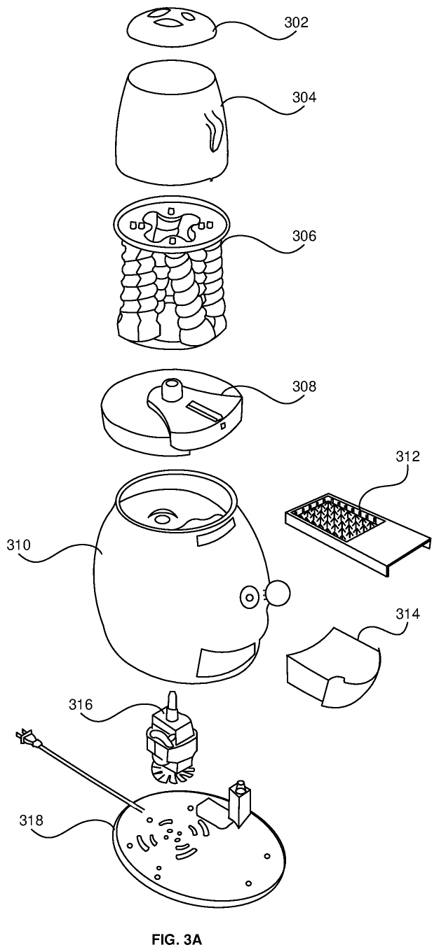

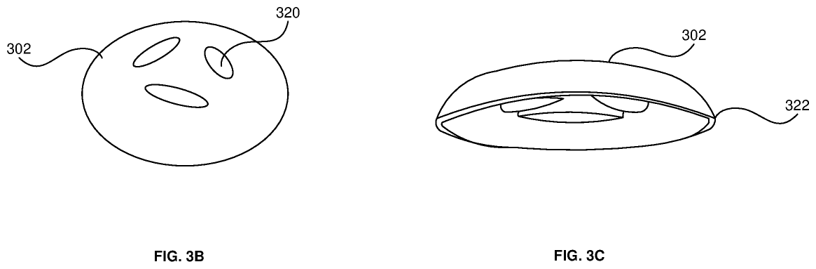

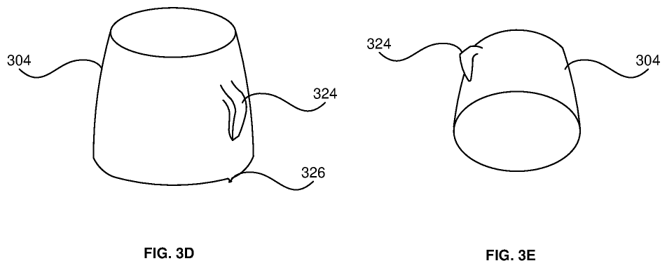

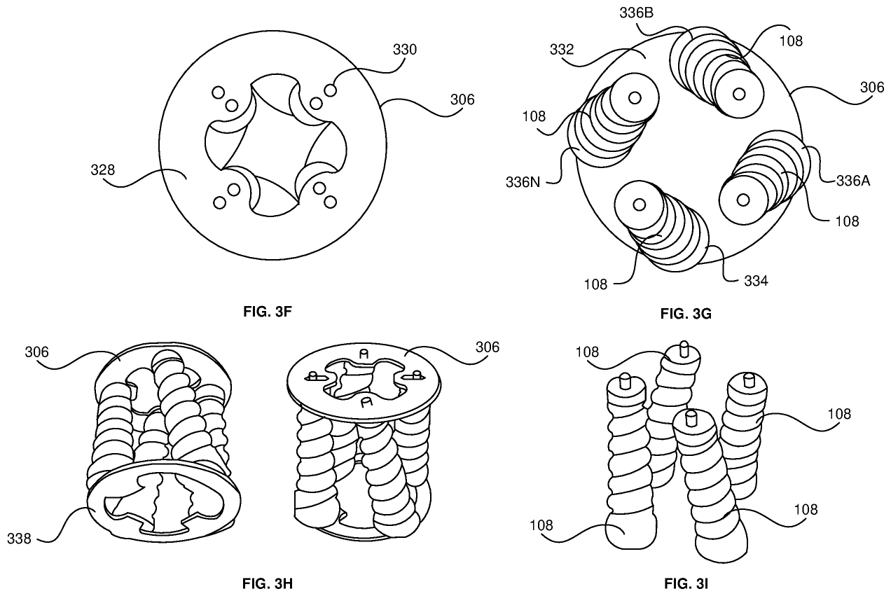

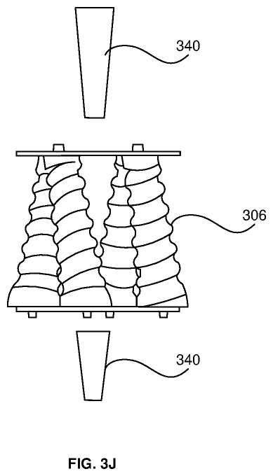

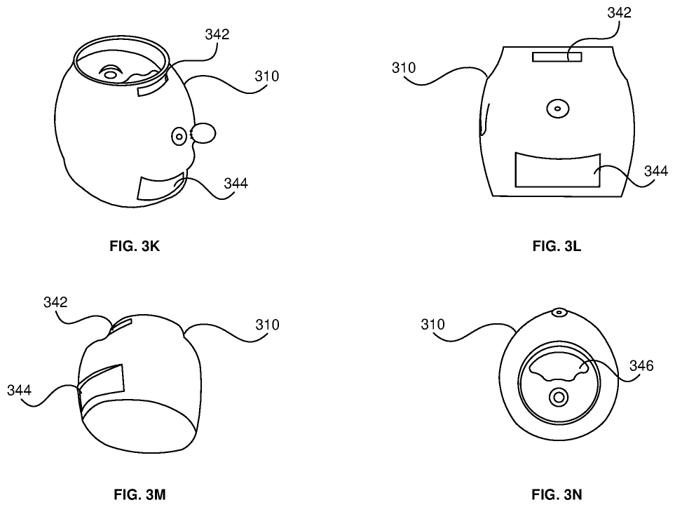

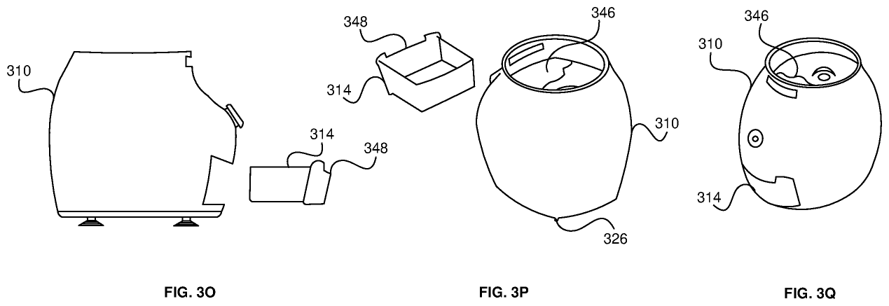

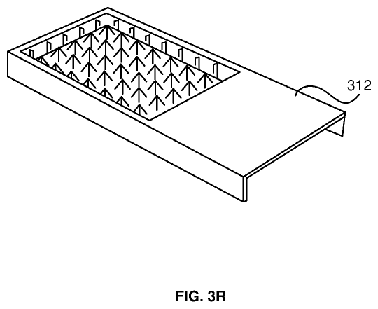

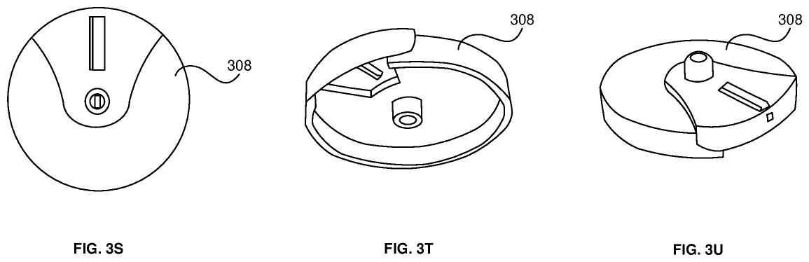

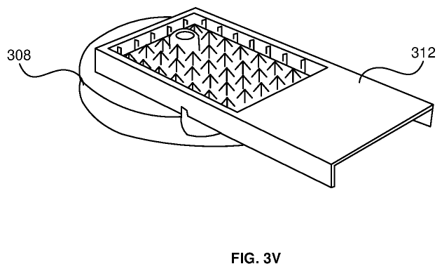

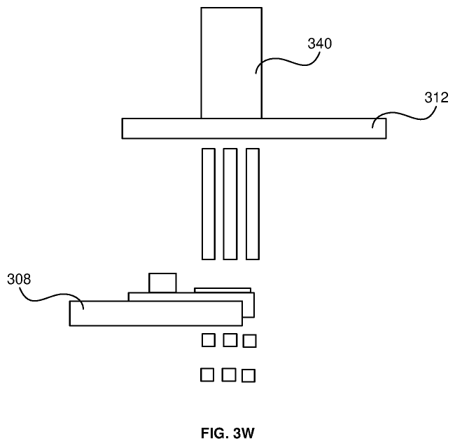

FIGS. 3A-3W illustrate exemplary views of the automatic food item feeder and processor system 100 of FIG. 2 according to some embodiments herein. FIG. 3A illustrates an exemplary exploded view of components of the automatic food item feeder and processor system of FIG. 2 according to some embodiments herein. The components of the automatic food item feeder and processor system 100 includes a cap 302, a jar 304, a feeder mechanism 306, a circular blade 308, a main body 310, a blade mesh 312, a collecting tray 314, an electric motor 316, and a base enclosure 318.

FIGS. 3B and 3C illustrate perspective top view and bottom view of the cap 302 of the automatic food item feeder and processor system 100 of FIG. 3A according to some emdbodiments herein. The cap 302 is configured to prevent any material from entering into the automatic food item feeder and processor system 100 when not in use. The cap 302 includes a cap opener 320 in a top position, a first sensor 322, and a circuit. The cap opener 320 enables the user to open the top portion of the automatic food item feeder and processor system 100. The first sensor 322 is configured to complete the circuit that is connected along with the jar 304. In some embodiments, when the cap 302 is open, the circuit remains incomplete, and the electric motor cannot be turned ON, and when the cap 302 is closed, the circuit is completed, and the electric motor 316 can be switched ON.

FIGS. 3D and 3E illustrate perspective side view and bottom view of the jar 304 of the automatic food item feeder and processor system 100 of FIG. 3A according to some emdbodiments herein. The jar 304 is made of a transparent material that prevents the at least one food item from spilling out from the automatic food item feeder and processor system 100. The transparent material allows the user to easily monitor the amount of the at least one food item remaining in the jar 304. In some embodiments, the transparent material can be a high-quality glass or durable Bisphenol A, BPA-free plastic. The jar 304 includes a handle 324, and a second sensor 326. The handle 324 is a ergonomic handle that is configured to allow the user to lift the jar from the automatic food item feeder and processor system 100. In some embodiments, the handle 324 is made of durable materials including plastic, metal or wood, which provides a comfortable and secure grip in lifting the jar 304 and ensures transportation of the jar 304 without any risk of dropping or spilling of the at least one food item. The second sensor 326 is at the bottom of the jar 304 that connects with the main body 310 of the automatic food item feeder and processor system 100 to complete the circuit. In some embodiments, when the cap 302 is open, the circuit remains incomplete which is determined by the first sensor 322 and the second sensor 326, and the electric motor 316 cannot be turned ON ensuring safe operation and prevents accidental activation when the cap 302 is open. In some embodiments, when the cap 302 is closed, the circuit is completed which is determined by the first sensor 322 and the second sensor 326, and the electric motor 316 can be switched ON for the food processing. In some embodiments, the second sensor connects with the collection tray 314 for completing the circuit.

FIGS. 3F-3I illustrate exemplary views of the feeder mechanism 306 of the automatic food item feeder and processor system 100 of FIG. 3A according to some emdbodiments herein. FIG. 3F shows a top view of the feeder mechanism 306. The feeder mechanism 306 includes a top guideway plate 328, a spring mechanism 330, and a bottom guideway plate 332. The top guideway plate 328 and the bottom guideway plate 332 are placed above and below the helical conical roller shafts 108, that limits the size of the at least one food item to be processed. The spring mechanism 330 enables an inside movement and an outside movement of the helical conical roller shafts 108 to grip the at least one food item inside the helical conical roller shafts 108. The helical conical roller shafts 108 includes one or more drive roller shafts and one or more driven roller shafts. The one or more drive roller shafts are configured to initiate the rotary motion and the one or more driven roller shafts are configured to drive by the one or more drive roller shafts, that creates the feed motion for the at least one food item in the automatic food item feeder and processor system 100. The one or more drive roller shafts and the one or more driven roller shafts may be oriented in any of a vertical position, a vertical slanting position, a horizontal position, or a horizontal slanting position, to create the required feed motion in the automatic food item feeder and processor system 100. In some embodiments, the spring mechanism 330 enables both contraction motion or expansion motion for the one or more drive roller shafts and the one or more driven roller shafts. The contraction motion may be the inside movement and the expansion motion may be the outside movement of the spring mechanism 330. For example, if the at least one food item is small, the spring mechanism 330 enables the contraction motion in the one or more driver roller shafts and the one or more driven roller shafts for gripping and feeding the small food item precisely. In another example, if the at least one food item is large, the spring mechanism enables the expansion motion in the one or more driver roller shafts and the one or more driven roller shafts for gripping and feeding the large food item in the steady and consistent motion.

FIG. 3G shows a top view of the feeder mechanism 306 without the top guideway plate 328. The feeder mechanism 306 includes the helical conical roller shafts 108 including a driver roller shaft 334, and one or more driven roller shafts 336A-N. The drive roller shaft 334 and the one or more driven roller shafts 336A-N automates the feeding operation of the at least one food item by gripping and pushing the at least one food item to the cutting portion 106.

FIG. 3H shows a top perspective and a bottom perspective views of the feeder mechanism 306. The feeder mechanism 306 includes a drive motor 338 for propelling the drive roller shaft 334. FIG. 3I shows a top perspective view of the feeder mechanism 306 without guideway plates. The feeder mechanism 306 includes the helical conical roller shafts 108 that is provided in a slant orientation that enables the contraction motion and the expansion motion of the helical conical roller shafts 108 for accommodating different food item sizes i.e. the small food item as well as the large food item.

FIG. 3J illustrates an exemplary front view of the feeder mechanism 306 of the automatic food item feeder and processor system 100 of FIG. 3F according to some emdbodiments herein. The exemplary front view shows a food item 340 that is entering the feeder mechanism 306, and the food item 340 that is guided through the feeder mechanism 306 without any movement or misalingment.

FIGS. 3K-3N illustrate exemplary views of the main body 310 of the automatic food item feeder and processor system 100 of FIG. 3A according to some emdbodiments herein. FIGS. 3K and 3L shows a side perspective view and a front view of the main body 310, that includes a meshblade opening 342, and a collection tray opening 344. The meshblade opening 342 allows for an insertion of blades into the main body 310. In some embodiments, mesh blades are inserted through the meshblade opening 342 of the main body 310. The mesh blades may include one or more small blades arranged in a mesh-like pattern, to cut and blend the at least one food item. Once processed, the processed food items can be easily removed from the the collection tray through the collection tray opening 344. FIGS. 3M and 3N shows a bottom perspective view and a top view of the main body 310, that includes a tunnel 346 in the top portion. The tunnel 346 is configured to direct the processed food item into the collection tray 314 for the efficient and reliable transfer of the processed food item into the collection tray 314.

In some embodiments, the main body 310 can be a base that accommodate various attachments, enabling multiple food processing functions. The main body 310 may be a robust body made of a plastic material.

FIGS. 30-3Q illustrate exemplary views of the main body 310 with the collection tray 314 of FIG. 3L according to some emdbodiments herein. FIGS. 30 and 3P shows a side view and a top perspective view of the main body 310 with the collection tray 314 in an open position. The collection tray 314 includes an intergrated handle 348 that enables opening and closing of the collection tray 314 from the main body 310 using a smooth pull and push mechanism. FIG. 3Q shows a side perspective view of the main body 310 with the collection tray 314 in a closed position, which enables the collection tray 314 to receive the processed food item from the tunnel of the main body 310. The collection tray 314 may include a third sensor at a bottom portion that slides to enable the circuit to complete and turn ON the electric motor 316 for the food processing. In some embodiments, when the collection tray 314 is in the open position, the circuit remains incomplete which is determined by the first sensor 322, the second sensor 326, and the third sensor, and the electric motor 316 cannot be turned ON ensuring safe operation. In some embodiments, when the collection tray 314 is in the closed position, the circuit is completed which is determined by the first sensor 322, the second sensor 326, and the third sensor, and the electric motor 316 can be switched ON for the food processing. The collection tray 314 may be wide and spacious to accommodate a greater number of the processed food items.

FIG. 3R illustrates an exemplary view of the blade mesh 312 according to some embodiments herein. The blade mesh 312 is configured to inserted through the meshblade opening 342 of the main body 310. In some embodiments, the blade mesh 312 is made of SS304 material that is durable, corrosion-resistant, and food-safe properties. The blade mesh 312 may be moulded with food-grade plastic frame. The blade mesh 312 may be provided with one or more patterns of steel mesh and one or more grid sizes for the food processing to achieve desired structure and consistency of the at least one food item. In some embodiments, the blade mesh 312 can be easily replacable using the meshblade opening 342.

FIGS. 3S-3U illustrate exemplary views of the circular blade 308 according to some embodiments herein. The circular blade 308 includes a plastic round frame with a cut-out sector to accommodate a blade. In some embodiments, the circular blade 308 includes one or more blade profiles to facilitate the food processing with the one or more processes. The one or more blade profiles may include a slicing profile, a chopping profile, a shredding profile, or a grating profile. The circular blade 308 may be removable and washable, which makes easy to clean small pieces of food debris that stuck between the plastic round frame and the blade.

FIG. 3V illustrates an exemplary blade combination view of the blade mesh 312 of FIG. 3S and the circular blade 308 of FIGS. 3S-3U according to some embodiments herein. The blade combination of the blade mesh 312 and the circular blade 308 enables processing of the at least one food item in multiple stages to obtain the pre-determined requirement of the at least one food item. In some embodiments, the blade mesh 312 and the circular blade 308 are placed in a perpendicular shape for the multiple stages of cut in the at least one food item to obtain the required shapes and sizes of the at least one food item.

FIG. 3W illustrates an exemplary working view of the blade combination of FIG. 3V according to some embodiments herein. The exemplary view includes the food item 340, the blade mesh 312 and the circular blade 308. The food item 340 is configured to move into the blade mesh 312 that cut the food item 340 into one or more strips, and the one or more strips are configured to move into the circular blade 308 that cut the one or more strips into any of square cubes or slices of the food item 340.

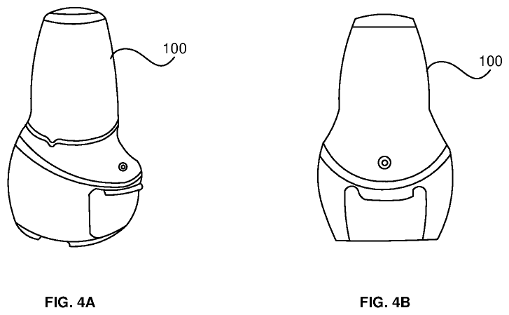

FIGS. 4A and 4B illustrate exemplary views of the automatic food item feeder and processor system 100 according to some embodiments herein. The functions and working of the automatic food item feeder and processor system 100 are explained above.

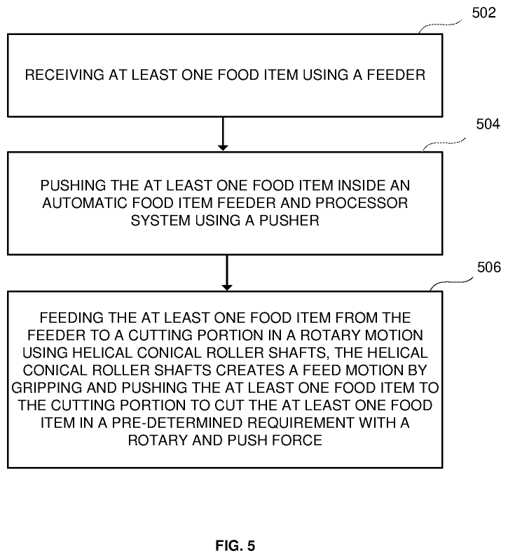

FIG. 5 illustrates a flow diagram of a method for cutting the at least one food item in the automatic food item feeder and processor system 100 according to some embodiments herein. At a step 502, the at least one food item is received using the feeder 102. At a step 504, the at least one food item is pushed inside the automatic food item feeder and processor system 100 using the pusher 104. At a step 506, the at least one food item is fed from the feeder to the cutting portion 106 in the rotary motion using the helical conical roller shafts 108. The helical conical roller shafts 108 creates the feed motion by gripping and pushing the at least one food item to the cutting portion 106 to cut the at least one food item in the pre-determined requirement with the rotary and push force.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

I/We claim:

1. An automatic food item feeder and processor system comprising:
a feeder that receives at least one food item;
a pusher that pushes the at least one food item inside the automatic food item feeder and processor system; and
a cutting portion that processes the at least one food item;
wherein, characterized in that, the automatic food item feeder and processor system comprise a feeder mechanism comprising helical conical roller shafts that feeds the at least one food item from the feeder to the cutting portion in a rotary motion, wherein, when in operation, the helical conical roller shafts are configured to create a feed motion by gripping and pushing the at least one food item to the cutting portion to cut the at least one food item in a pre-determined requirement with a rotary and push force.

2. The automatic food item feeder and processor system of claim 1, wherein the helical conical roller shafts further comprise one or more drive roller shafts and one or more driven roller shafts, wherein the one or more drive roller shafts are configured to initiate the rotary motion and the one or more driven roller shafts are configured to drive by the one or more drive roller shafts, that creates the feed motion for the at least one food item.

3. The automatic food item feeder and processor system of claim 2, wherein the one or more drive roller shafts and the one or more driven roller shafts are in any of a vertical position, a vertical slanting position, a horizontal position, or a horizontal slanting position, to create the feed motion in the automatic food item feeder and processor system.

4. The automatic food item feeder and processor system of claim 2, wherein the one or more drive roller shafts and the one or more driven roller shafts automates a feeding operation of the at least one food item by gripping and pushing the at least one food item to the cutting portion.

5. The automatic food item feeder and processor system of claim 1, wherein the helical conical roller shafts further comprise a spring mechanism that enables at least one of a contraction motion or an expansion motion of the one or more drive roller shafts and the one or more driven roller shafts.

6. The automatic food item feeder and processor system of claim 1, wherein the automatic food item feeder and processor system further comprises a guideway that is configured to confine a size of the at least one food item to enter into the feeder.

7. The automatic food item feeder and processor system of claim 1, wherein the automatic food item feeder and processor system further comprises a collector that receives the cut food items.

8. The automatic food item feeder and processor system of claim 1, wherein the automatic food item feeder and processor system comprises a control unit that is configured to perform the feeding operation of the at least one food item to the cutting portion.

9. The automatic food item feeder and processor system of claim 1, wherein the cutting portion comprises at least one of dicer blades, choppers, or rotary blades to cut the at least one food item, wherein the automatic food item feeder and processor system enables the cutting portion to any of chop, slice, mince, or grate the at least one food item.

10. A method for cutting at least one food item in an automatic food item feeder and processor system, wherein the method comprises:
receiving, using a feeder, the at least one food item;
pushing, using a pusher, the at least one food item inside the automatic food item feeder and processor system;
feeding, using helical conical roller shafts, the at least one food item from the feeder to a cutting portion in a rotary motion, wherein the helical conical roller shafts creates a feed motion by gripping and pushing the at least one food item to the cutting portion to cut the at least one food item in a pre-determined requirement with a rotary and push force.

11. The method as claimed in claim 10, wherein the method comprises,
creating, using one or more drive roller shafts and one or more driven roller shafts, the feed motion for the at least one food item, wherein the one or more drive roller shafts are configured to initiate the rotary motion and the one or more driven roller shafts are configured to drive by the one or more drive roller shafts.

12. The method as claimed in claim 11, wherein the method comprises,
automating, using the one or more drive roller shafts and the one or more driven roller shafts, a feeding operation of the at least one food item by gripping and pushing the at least one food item to the cutting portion.

13. The method as claimed in claim 10, wherein the method comprises,
enabling, using the helical conical roller shafts including a spring mechanism, at least one of a contraction motion or an expansion motion of the one or more drive roller shafts and the one or more driven roller shafts.

14. The method as claimed in claim 10, wherein the method comprises,
confining, using a guideway, a size of the at least one food item to enter into the feeder.

15. The method as claimed in claim 10, wherein the method comprises,
receiving, using a collector, the cut food items.

16. The method as claimed in claim 10, wherein the method comprises,
performing, using a control unit, the feeding operation of the at least one food item to the cutting portion
